(19) United States
(12) Patent Application Publication
(10) Pub. No.: US 2026/0083300 A1
(43) Pub. Date: Mar. 26, 2026

(54) BOTTLE DRYER

(71) Applicant: HILLARY VONAHSEN, DALLAS, TX (US)

(72) Inventor: HILLARY VONAHSEN, DALLAS, TX (US)

(21) Appl. No.: 19/281,976

(22) Filed: Jul. 28, 2025

Related U.S. Application Data
(63) Continuation of application No. 16/722,028, filed on Dec. 20, 2019, now abandoned.

(51) Int. Cl. A47L 19/00; A47L 15/48; A61J 9/00; F26B 25/06

(52) U.S. Cl. CPC A47L 19/00; A47L 15/48; A61J 9/00; F26B 25/06

(57) ABSTRACT

An apparatus and method to dry and maintain a moisture free environment inside of a bottle or small container includes an expandable and collapsible assembly shaped and sized for insertion into an open mouth of a bottle. The assembly includes at least one drying member with at least one adsorbent constituent, and is configured to change shape when an activating member is pushed, pulled, pivoted or twisted. The assembly, when expanded within the interior space of the bottle, resists accidental dislodgement from the bottle.

### CROSS REFERENCE TO RELATED APPLICATIONS

This Non-Provisional Utility application is a Continuation of U.S. Non-Provisional Utility application Ser. No. 16/722,028 with a filing date of Dec. 20, 2019.

### TECHNICAL BACKGROUND

This disclosure relates to an apparatus and method for the removal of excess moisture from interior surfaces of bottles and other containers.

### BACKGROUND

The importance of thoroughly drying baby bottles has been emphasized by health authorities. Babies less than 3 months old or those born prematurely are at higher risk for pathogens than older children. Typically, for higher risk children, bottles, nipples and rings are sterilized by boiling. In other cases, using a dishwasher or normal hand washing in hot soapy may suffice. Air drying instead of towel drying is recommended to prevent cross-contamination.

Baby bottles come in a variety of sizes and shapes. Some are generally cylindrical in shape both inside and out, while others have ergonomic features with relatively complex interior surfaces requiring additional drying time.

Known methods for drying cleaned baby bottles include air drying on bottle racks, baby bottle dryers such as the One Step ™ that sterilize by steam and dry by heat, and wiping the interior of the bottle with a clean cloth or paper towel. However, air drying on a bottle rack takes time and also risks contamination if the bottle rack is not kept scrupulously clean. While baby bottle driers well for their intended use, a busy parent may have to leave the house before the bottles are dry. Wiping with a towel can shed fibers and introduce bacteria, mold and other pathogens by cross-contamination. What is needed is a solution for travel moms and others with busy schedules that often leave them with little time to prepare.

It would be desirable to provide an apparatus and method for the removal of excess moisture from the interior surfaces of a bottle that remains after washing or sterilization.

It would be desirable to provide an apparatus and method whereby condensate is prevented from forming on the interior surfaces of a bottle.

It would be further desirable if such a drying apparatus were easily removable from a bottle without requiring the insertion of fingers or instruments into the interior space of the bottle.

It would be even further desirable if such a drying apparatus were configurable such that it stays inside a bottle when the bottle is inverted until the apparatus is manually removed.

### SUMMARY

A general implementation of an apparatus to eliminate residual moisture and prevent the formation of condensation in a bottle includes: an expandable and collapsible assembly including one or more drying members. The assembly is configured to include a first state where the one or more drying members are closely packed, and at least a second state where portions of the drying members are separable from other portions such that the surface area of the drying members directly exposed to the interior atmosphere of the bottle is increased.

In a first aspect combinable with the general implementation, the assembly includes a state activating member.

In a second aspect combinable with any other aspect, the assembly includes a collapsed state.

In a third aspect combinable with any other aspect, the assembly includes a sorbent portion.

In a fourth aspect combinable with any other aspect, the foregoing sorbent portion may be a desiccant.

In a fifth aspect combinable with any other aspect, the drying members may be bendable, foldable or segmented.

In a sixth aspect combinable with any aspect, the drying members may include an adsorbent portion.

In a seventh aspect combinable with any other aspect, the drying members may include a fibrous cellulose portion.

In an eighth aspect combinable with any other aspect, the drying members may include a silica gel portion.

In a ninth aspect combinable with any other aspect, the drying members may include a molecular sieve portion.

In a tenth aspect combinable with any other aspect, the drying members may be pre-sterilized.

In an eleventh aspect combinable with any other aspect, the assembly may include a non-moisture absorbing cover which may include perforations.

In a fourteenth aspect combinable with any other aspect, the assembly may include an activated carbon portion.

In a fifteenth aspect combinable with any other aspect, the assembly may include a sodium bicarbonate portion.

In a twelfth aspect combinable with any other aspect, when pulled, pushed or twisted, a state activating member causes the assembly to change shape, expand, contract, or collapse.

In a thirteenth aspect combinable with any other aspect, a state activating member may be a string, cord, tab or slidable member.

In a fourteenth aspect combinable with any other aspect, the assembly may be comprised substantially of natural and organic elements.

Advantages and features of the present invention include but are not limited to: drying bottles and other containers after the containers have been washed and set aside to air dry; lowering the atmospheric moisture fraction inside the bottle; preventing condensate from forming on interior bottle surfaces; and, producing an interior environment resistant to bacteria and mold growth.

The foregoing general and specific aspects may be implemented using a device, system or method, or any combinations of devices, systems, or methods, the details of which are set forth in the accompanying drawings and the description. Other features, objects, and advantages will be apparent from the description and drawings, and from the claims.

### BRIEF DESCRIPTION OF DRAWINGS

FIG. 1 is a perspective view of one example implementation of the bottle dryer in a fully collapsed state;

FIG. 2 is another perspective view thereof in a slightly expanded state;

FIG. 3 is a third perspective view thereof in a fully expanded state;

FIGS. 4A and 4B are perspective views of another example implementation showing a partially and fully expanded state;

FIGS. 5A and 5B show respectively, a top view and side elevation of the implementation shown in (FIG. 1);

FIGS. 6A, 6B, 6C and 6D illustrate the sequential insertion and removal of an example implementation; and,

FIGS. 7 and 8 are perspective views of other example implementations of the present invention.

### REFERENCE LISTING OF THE NAMED ELEMENTS

100 dryer assembly
102 drying member
104 activating member
106 connection
108 joint
109 fold line
110 perforation/aperture
111 score line
112 drying agent
114 hinge
116 segment
118 moisture indicator
120 fibrous portion
122 substrate/backing

### DETAILED DESCRIPTION

The term “desiccant” means a hygroscopic material used as a drying agent and includes, but is not limited to: silicas, silica gels, cellulose fiber, and carbon. The term “molecular sieve” means a substance that includes small pores of a size range that is suited to trapping portions of a solution or gas by adsorption that are passed through the sieve. Examples of molecular sieves include natural and synthetic zeolytes, activated carbon and some clays. Pore size of the sieve determines the suitability for trapping different fractions of a substance. The term “desiccant paper” refers to a fibrous matrix embedded with one or more desiccants. “Adsorption” refers to a process whereby molecules of a substance are adhered to a surface. “Absorption” refers to a process whereby molecules of a substance are taken into and distributed evenly throughout the volume of another material or substance. In the detailed description that follows, the singular terms “a”, “an”, and “the” include plural referents unless the context clearly indicates otherwise. Similarly, the word “or is intended to include “and” unless the context clearly indicates otherwise. Although methods and materials similar or equivalent to those described herein can be used in the practice or testing of this disclosure, suitable methods and materials are described below. It should be understood that the objects, features and aspects of any implementation/embodiment disclosed herein may be combined with any object, feature or aspect of any other implementation/embodiment without departing from the scope of the invention. The term “comprises” means “includes.” All publications, patent applications, patents, and other references mentioned herein are incorporated by reference in their entirety for all purposes. In case of conflict, the present specification, including explanations of terms, will control. In addition, the materials, methods, and examples are illustrative only and not intended to be limiting.

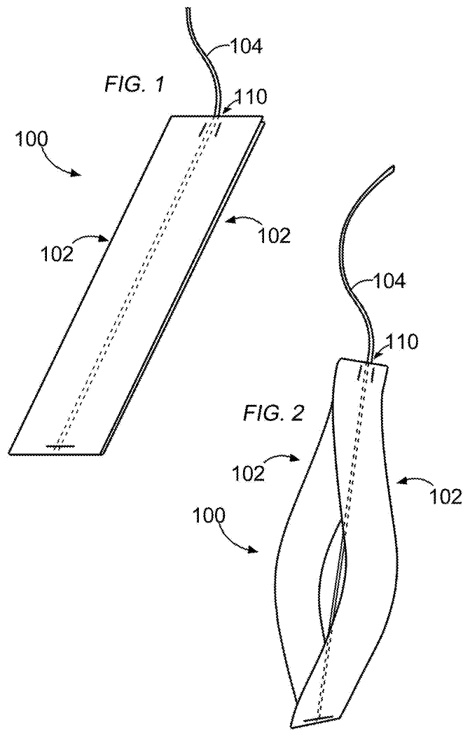

As depicted in FIGS. 1-7, an apparatus for drying and maintaining a moisture free environment inside a bottle includes a dryer assembly (100) that includes at least one drying member (102) and at least one desiccant component. The drying member(s) may include a matrix of cellulose fibers (120) and a drying agent (112) such as silica gel, a clay or zeolite. The drying members are capable of transitioning from a collapsed disposition to an expanded shape when an activating member (104) is manipulated by twisting, bending, pulling or pushing. Segments (116) of the drying members may be seamlessly connected (106) or joined. One portion of the activating member (104) may be attached to portions of the assembly, whereas another portion of the activating member may be movable; e.g., through an aperture, or around the drying members (102). The drying members may include one or more fold lines (109) hinges (114) or joints (108) wherein sections of the drying members pivot in relation to adjacent sections of the drying members. Drying members may be ofnvarying thicknesses and perforated (110) or non-perforated. If perforated, the perforations can be of any size or shape.

FIG. 1 is a perspective view showing an example implementation of the present invention in a fully collapsed state, the dryer assembly (100) having been removed from packaging if any, and, including one or more drying members (102), and an activating member (104) which in the particular implementation shown is a short string or cord attached to portions of a dryer assembly (100). It should be understood that the dryer assembly is sized and shaped for the particular container. In the case of baby bottles, a typical, but non-limiting length of the collapsed assembly may be from 5 cm-12 cm.

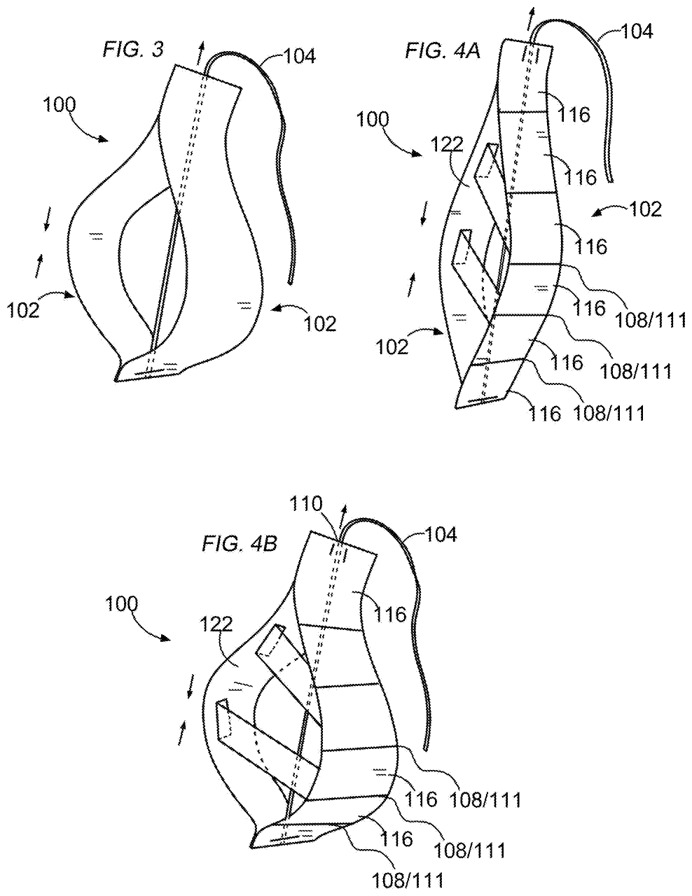

FIGS. 2 and 3 are perspective views illustrating the expansion of the dryer assembly (100) when the activating member (104) is pulled in the direction of the arrow via the gap or aperture (110) between the joined drying members (102). Typically, the assembly may be expanded by lightly grasping the activating member, and pulling it by the dominant hand, while grasping the top of the assembly with the other hand. A string (104) is slidable through the upper part of the assembly, and firmly attached to the bottom part of the assembly. Pulling the string draws the lower part of the assembly to the upper part and thereby expands portions of the assembly radially away from the string which may be thought of as an axis in the particular implementation shown. In some implementations, the activating member may be a rigid element such as a small length of plastic, wood or paper that is pushed or pulled to expand portions of the assembly (100). In other implementations, the activating member (104) may be a tab connected to the assembly that is twisted or pivoted to expand the structure. In the particular implementation shown, the assembly includes two rectangular drying members (102) that are sandwiched in the fully collapsed state (FIG. 1), and which are forced apart by pulling the activating member. The drying members (102) may include desiccant paper which is typically a compressed matrix of silica gel and cellulose fibers (120) but which can substitute or contain zeolites or other sorbents. Desiccant materials may be suitable as long as they are non-toxic and leave no residue when the drying members are removed from the container. In some example implementations, thickness of the desiccant paper is between 5 to 20 mils. In other implementations the thickness is between 12 and 60 mils. Thickness may vary according the configuration of the assembly. In some implementations, the drying members simply bow or flex away from one another when the assembly is expanded. In other implementations, the drying members are sufficiently thick so that scoring or fold lines (109) of the drying members enables them to move away from one another. In some cases, the drying members are formed in such a way to exhibit memory characteristics. In some cases, the drying members have a backing of a substrate (122) that is highly bendable or exhibits memory characteristics. In whatever implementation, it is possible that materials of the dryer assembly may be reusable, organic and recyclable. The dryer assemblies may not be limited to rectangular shapes-but may be shaped, sized and include indicia or coloring according to consumer preferences.

FIGS. 4A and 4B illustrate respectively, a partially and fully expanded implementation that includes scored (111) drying members (102) joined to a bendable backing or substrate (122). In some implementations drying members (102) may be composed of separate segments (116) that abut edge to edge or are separated by a space and connected (106) by another element such as a backing sheet (122). Folded/sandwiched intermediary drying members (102) in the collapsed state may bridge; e.g., fold out to fill/span the space between other drying members as illustrated when the assembly is expanded, providing additional desiccant surface area.

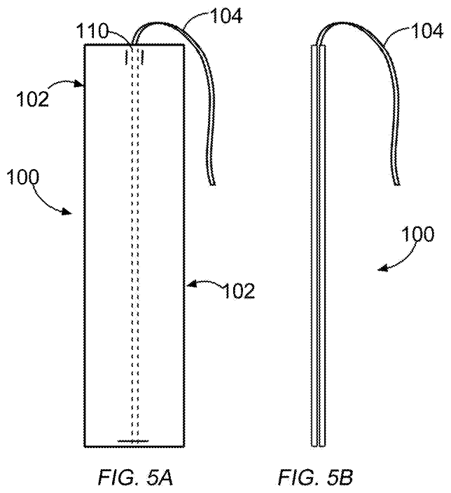

FIGS. 5A and 5B are front and right side elevations of a simple collapsed assembly with two drying members (102).

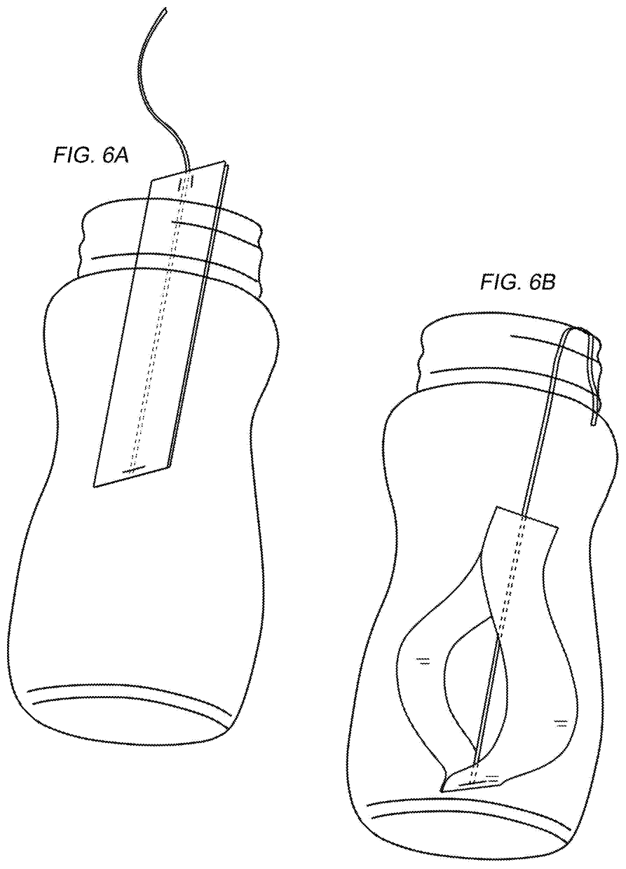

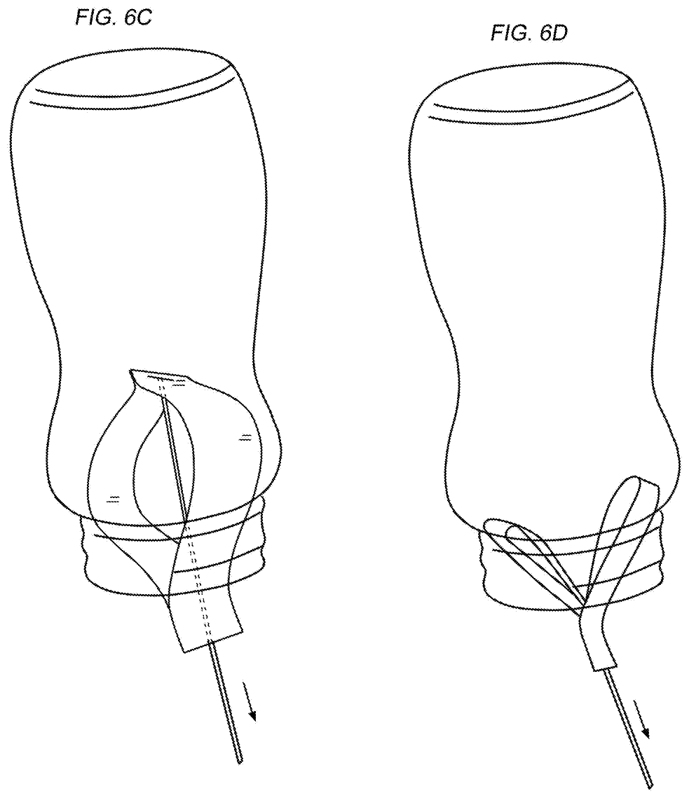

Thicknesses shown are for illustrative purposes only and do not represent true scale. Drying members are here shown to be non-segmented which is typical if the drying members are sufficiently thin. Thicker drying members may be scored or segmented to aid in bending or folding away from a central axis.
FIGS. 6A, 6B, 6C and 6D illustrate a sequential insertion and removal of an example implementation. In a first example step, a dryer assembly (100) is inserted through the mouth of a bottle. In a second example step (FIG. 6B), the assembly is expanded within the bottle as shown. In a third example tep (FIG. 6C), the bottle is inverted, and in a fourth example step (FIG. 6D), the activating member is pulled causing a collapse and inversion of the assembly elements such that the assembly is removed from the bottle.

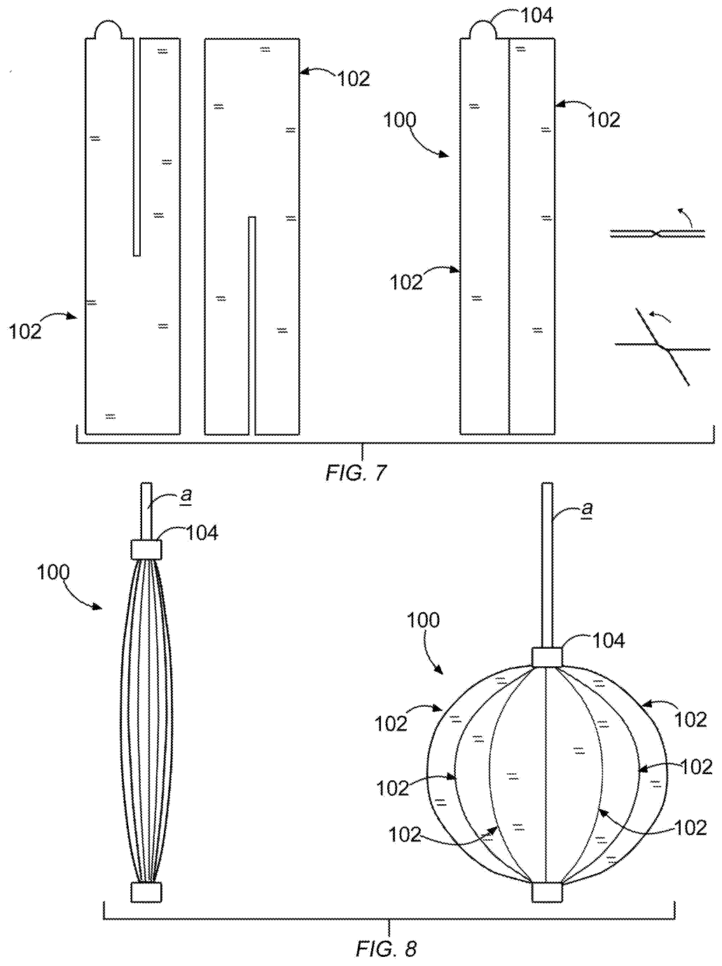

FIG. 7 shows an implementation including drying members (102) having the form of interlinked; for example via slots stamped in the drying members and form pivoting panels that scissor when pivoted. The activating member (104) in this case is a tab formed from one of the panels. Edge views show the disposition of the panels in a collapsed state and after expansion. FIG. 8 shows an implementation that includes drying members (102) that are caused to move away from an axis when the activating member (104) is pushed, pulled or twisted. In FIG. 8. the activating member (104) is a ring circumjacent axis (a). Ends of a pleated desiccant sheet are affixed to the ring which is slidable down axis (a) which may be a paperboard tube. When the ring is pushed down axis (a), ends of the pleated drying members are pushed together and the midsection expands radially. In some implementations, twisting the activating member (104) may cause unidirectional circumjacently packed flaps; e.g., similar to a closed umbrella, to unfurl and move away from an axis.

Any of the implementations described can be packaged singly or in multi-packs. Materials employed in the construction of the assembly may be organic and derived from naturally occurring materials. In some implementations, the dryer assembly may be expanded prior to bottle insertion.

It should be understood that the drawings and detailed description herein are to be regarded in an illustrative rather than a restrictive manner, and are not intended to be limiting to the particular implementations, forms and examples disclosed. Accordingly, it is intended that this disclosure encompass any further modifications, changes, rearrangements, substitutions, alternatives, design choices, and implementations as would be appreciated by those of ordinary skill in the art having benefit of this disclosure, and falling within the spirit and scope of the following claims.

What is claimed is:

1. A bottle drying apparatus, comprising: an expandable and collapsible assembly including: one or more drying members; a first state where the one or more drying members are closely packed, and a second state where portions of some of the drying members are separated from portions of other drying members such that surface area of the drying members exposed to the interior atmosphere of a container is increased compared to the first state.

2. The apparatus according to claim 1, further comprising a shape activating member.

3. The apparatus according to claim 1, the one or more drying members further comprising a desiccant portion.

4. The apparatus according to claim 1, further comprising at least a collapsed shape and an expanded shape.

5. The apparatus according to claim 1, the assembly expandable to a shape lodgeable in the container.

6. The apparatus according to claim 1, the assembly collapsible to a shape dislodgeable from the container.

7. The apparatus according to claim 1, further comprising a fibrous portion.

8. A method of drying the interior atmosphere of a container comprising the steps of: providing a collapsible and expandable assembly including one or more drying members, the one or more drying members at least transitionable from a collapsed state to an expanded state that increases surface area exposed to the container atmosphere; inserting the assembly into the container; expanding the assembly; removing the assembly from the container.

9. The method according to claim 8 further comprising a step of collapsing the assembly prior to removal from the container.

10. The method according to claim 8 wherein the assembly includes a shape activating member.

11. The method according to claim 8 wherein the assembly includes a desiccant.
